(19) United States
(12) Patent Application Publication
(10) Pub. No.: US 2017/0241308 A1
(43) Pub. Date: Aug. 24, 2017

(54) OIL MAINTENANCE STRATEGY FOR ELECTRIFIED VEHICLES

(71) Applicant: FORD GLOBAL TECHNOLOGIES, LLC, Dearborn, MI (US)

(72) Inventors: Erik DONDZILA, Canton, MI (US); Ted HALADYNA, Northville, MI (US)

(21) Appl. No.: 15/051,994

(22) Filed: Feb. 24, 2016

(51) Int. Cl. F01M 5/00; B60K 6/40; B60K 6/28; B60K 6/365; B60K 6/24; B60K 6/445

(52) U.S. Cl. CPC F01M 5/001; B60K 6/24; B60K 6/445; B60K 6/28; B60K 6/365; B60K 6/40; B60Y 2400/112; B60Y 2200/92; Y10S 903/905; Y10S 903/907; Y10S 903/91; Y10S 903/951

(57) ABSTRACT

A method according to an exemplary aspect of the present disclosure includes, among other things, selectively powering a heating device to augment heating of an engine oil associated with an engine of a vehicle in a manner that influences an oil quality value of the engine oil.

### TECHNICAL FIELD

This disclosure relates to an oil maintenance strategy within a vehicle. The exemplary strategy includes actuating a heating device to augment heating of engine oil of the electrified vehicle in a manner that influences the quality of the engine oil.

### BACKGROUND

The need to reduce automotive fuel consumption and emissions is well known. Therefore, vehicles are being developed that reduce or completely eliminate reliance on internal combustion engines. Electrified vehicles are one type of vehicle currently being developed for this purpose. In general, electrified vehicles differ from conventional motor vehicles because they are selectively driven by one or more battery powered electric machines. Conventional motor vehicles, by contrast, rely exclusively on the internal combustion engine to drive the vehicle.

Contaminants such as oil, gas and water must be periodically removed from the oil of an internal combustion engine to achieve efficient operation and for engine protection. Electrified vehicles equipped with internal combustion engines, such as hybrid vehicles, typically include a passive oil minder feature that forces the internal combustion engine into high power operation for a sufficient duration in order to help evaporate the contaminants Forced engine operation may be undesirable and time consuming.

### SUMMARY

A method according to an exemplary aspect of the present disclosure includes selectively powering a heating device to augment heating of an engine oil associated with an engine of a vehicle in a manner that influences an oil quality value of the engine oil.

A further non-limiting embodiment of the foregoing method includes determining a measured oil quality value of the engine oil.

A further non-limiting embodiment of either of the foregoing methods includes estimating the measured oil quality value based on at least one operating condition of the internal combustion engine.

A further non-limiting embodiment of any of the foregoing methods includes estimating the measured oil quality value based on a number of cold starts of the internal combustion engine.

A further non-limiting embodiment of any of the foregoing methods includes comparing the measured oil quality value to an oil quality target value.

A further non-limiting embodiment of any of the foregoing methods includes continuing to actively monitor the measured oil quality value if the measured oil quality value exceeds the oil quality target value.

A further non-limiting embodiment of any of the foregoing methods includes powering the heating device with a battery pack.

A further non-limiting embodiment of any of the foregoing methods includes powering the heating device by running the engine at a power level that exceeds driver demanded power and then utilizing the excess power to power the heating device.

A further non-limiting embodiment of any of the foregoing methods includes opening a valve to allow coolant that is heated by the heating device to be communicated to the engine in order to heat the engine oil.

A further non-limiting embodiment of any of the foregoing methods includes closing the valve and turning the heating device OFF after a predefined amount of time.

A method according to another exemplary aspect of the present disclosure includes warming an engine coolant with heat generated by a heating device of a conditioning system configured to condition an engine of an electrified vehicle, and warming engine oil with the engine coolant to a temperature sufficient to remove contaminants from the engine oil.

A further non-limiting embodiment of the foregoing method includes opening a valve of the conditioning system to communicate the engine coolant heated by the heating device to the engine.

A further non-limiting embodiment of either of the foregoing methods includes comparing a measured oil quality value to an oil quality target value prior to warming the engine coolant.

A further non-limiting embodiment of any of the foregoing methods includes warming the engine coolant if the measured oil quality value is less than the oil quality target value.

A further non-limiting embodiment of any of the foregoing methods includes turning the heating device OFF after a predefined amount of time if the measured oil quality value exceeds the oil quality target value.

An electrified vehicle according to another exemplary aspect of the present disclosure includes a battery pack configured to selectively power a set of drive wheels, an engine configured to selectively power the drive wheels, a conditioning system configured to condition the engine and a control system configured to control the conditioning system to influence an oil quality value of oil of the engine.

A further non-limiting embodiment of the foregoing electrified vehicle includes a heating device configured to heat an engine coolant that is used to heat the oil.

A further non-limiting embodiment of either of the foregoing electrified vehicles includes the heating device configured as a positive temperature coefficient (PTC) heater.

A further non-limiting embodiment of any of the foregoing electrified vehicles includes the control system configured to open a valve and actuate a heating device to influence the oil quality value of the oil.

A further non-limiting embodiment of any of the foregoing electrified vehicles includes a primary coolant loop and a secondary coolant loop.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a vehicle system of an electrified vehicle.

FIG. 3 schematically illustrates a control strategy for influencing the quality of engine oil used by an engine of an electrified vehicle.

FIG. 4 is a graphical representation of an engine oil quality measurement.

### DETAILED DESCRIPTION

This disclosure details an exemplary oil maintenance strategy for controlling a vehicle equipped with an engine. A heating device may be selectively powered to influence the oil quality of engine oil. Once actuated, the heating device generates heat for warming an engine coolant that is passed through the engine. The engine coolant gives off heat to the engine oil through the engine structure to warm the engine oil. Warming the engine oil in this manner allows contaminants to be cleaned (e.g., boiled) out of the oil, thereby improving an oil quality value of the engine oil. The use of the auxiliary heating device can shorten the duration of the oil maintenance strategy, allowing the vehicle to return to a normal mode of operation sooner. These and other features are discussed in greater detail in the following paragraphs of this detailed description.

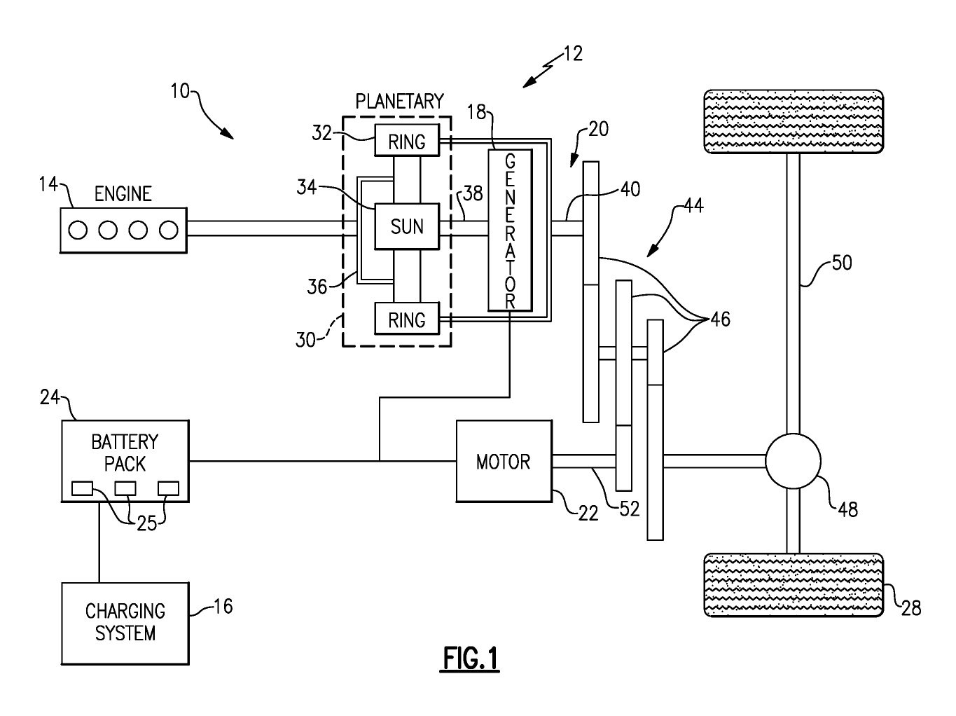

FIG. 1 schematically illustrates a powertrain 10 for an electrified vehicle 12. In one non-limiting embodiment, the electrified vehicle 12 is a plug-in hybrid electric vehicle (PHEV). However, other electrified vehicles could also benefit from the teachings of this disclosure, including but not limited to, battery electric vehicles (BEV's) and hybrid electric vehicles (HEV's). The teachings of this disclosure are further applicable to conventional motor vehicles.

In one non-limiting embodiment, the powertrain 10 is a power-split powertrain system that employs a first drive system and a second drive system. The first drive system may include a combination of an engine 14 and a generator 18 (i.e., a first electric machine). The second drive system includes at least a motor 22 (i.e., a second electric machine) and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28. In one embodiment, the power transfer units 30, 44 are part of a transaxle 20 of the electrified vehicle 12.

The motor 22 can also be employed to drive the vehicle drive wheels 28 by outputting torque to a shaft 52 that is also connected to the second power transfer unit 44. In one embodiment, the motor 22 is part of a regenerative braking system. For example, the motor 22 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18 and/or other electrical loads of the electrified vehicle 12. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

The electrified vehicle 12 may also include a charging system 16 for charging the energy storage devices (e.g., battery cells) of the battery pack 24. The charging system 16 may be connected to an external power source (e.g., electrical grid, not shown) for receiving and distributing power throughout the vehicle. The charging system 16 may also be equipped with power electronics used to convert AC power received from the external power supply to DC power for charging the energy storage devices of the battery pack 24. The charging system 16 may also accommodate one or more conventional voltage sources from the external power supply (e.g., 110 volt, 220 volt, etc.).

The powertrain 10 shown in FIG. 1 is highly schematic and is not intended to limit this disclosure. Various additional components could alternatively or additionally be employed by the powertrain 10 within the scope of this disclosure.

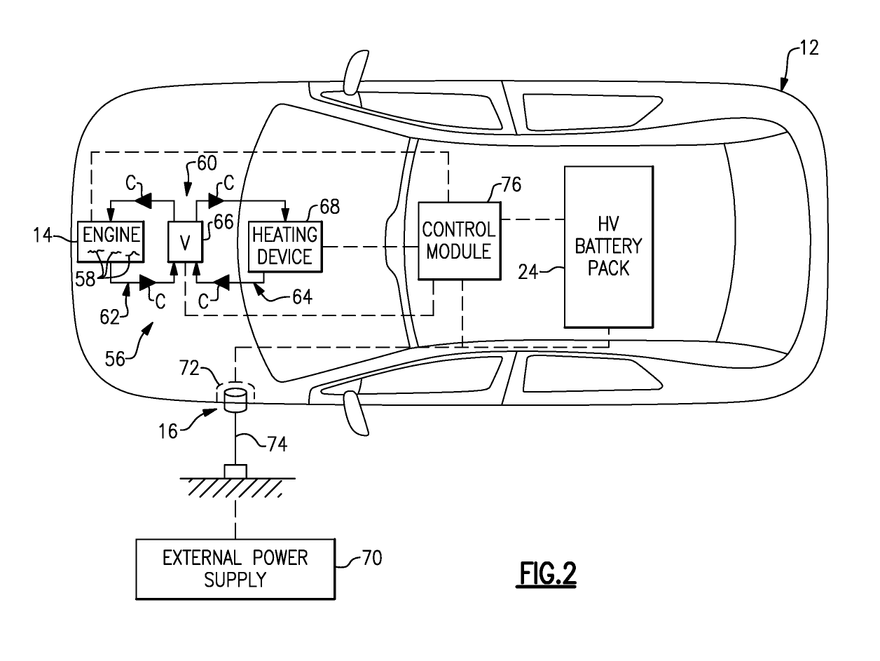

FIG. 2 is a highly schematic depiction of a vehicle system 56 that may be employed by an electrified vehicle, such as the electrified vehicle 12 of FIG. 1. The various components of the vehicle system 56 are shown schematically to better illustrate the features of this disclosure. These components, however, are not necessarily depicted in the exact locations where they would be found in an actual vehicle and are not necessarily shown to scale.

The vehicle system 56 is adapted to schedule and effectuate conditioning (e.g., warming) of oil 58 of the engine 14 in a manner that influences an oil quality value of the oil 58. The oil quality value is a calibrated expression of the amount of contaminants, such as fuel and water, present in the oil 58. In one non-limiting embodiment, the oil 58 is heated to a desired temperature to clean the oil 58 of the contaminants. Conditioning the oil 58 during certain vehicle conditions may improve the fuel efficiency, durability, customer satisfaction and electric range of the electrified vehicle 12, among providing other potential benefits.

In one non-limiting embodiment, the exemplary vehicle system 56 includes the engine 14, a conditioning system 60, a high voltage battery pack 24, a charging system 16 and a control module 76. The engine 14 may be an internal combustion engine or any other type of engine. The engine 14 houses and circulates the oil 58, which has an optimal operating temperature range, to lubricate the various components of the engine 14.

The conditioning system 60 is configured to thermally manage the engine 14. In one non-limiting embodiment, the conditioning system 60 includes a primary coolant loop 62 and a secondary coolant loop 64. The primary coolant loop 62 and the secondary coolant loop 64 each circulate a coolant C, such as with a pump (not shown). Although not shown, the conditioning system 60 may additionally include one or more heat exchangers for conditioning the coolant C within the primary coolant loop 62 and/or the secondary coolant loop 64. The secondary coolant loop 64 may be configured to both augment conditioning of the engine 14 and to condition the interior cabin of the electrified vehicle 12. During some conditions, excess heat is transferred from the engine 14 to the coolant C within the primary coolant loop 62. During other conditions, the secondary coolant loop 64 is fluidly connected to the primary coolant loop 62 to warm the oil 58 of the engine 14 by transferring heat from the coolant C into the oil 58, as further discussed below.

A valve 66 controls the flow of coolant C between the secondary coolant loop 64 and the primary coolant loop 62. For example, when the valve 66 is closed, the secondary coolant loop 64 is fluidly isolated or separated from the primary coolant loop 62. The valve 66 may be selectively opened to fluidly connect or combine the secondary coolant loop 64 and the primary coolant loop 62.

A heating device 68 may be positioned within the secondary coolant loop 64. The heating device 68 is configured to selectively condition the coolant C within the secondary coolant loop 64, such as by warming it. In one non-limiting embodiment, the heating device 68 is a positive temperature coefficient (PTC) heater positioned in direct contact with the coolant C. In another non-limiting embodiment, the heating device 68 is an electrically powered heating device. Other heating devices are also contemplated within the scope of this disclosure.

In one non-limiting embodiment, the heating device 68 is powered by grid power when the vehicle is “on-plug” (i.e., plugged into an external power source 70 when the vehicle is OFF). In another non-limiting embodiment, the heating device 68 is powered by the battery pack 24 when the vehicle is “off-plug” (i.e., unplugged from the external power source 70) or during operation of the electrified vehicle 12. In yet another non-limiting embodiment, the heating device 68 is powered by a self-contained energy storage device, such as a separate battery or special reserve power supply. In yet another non-limiting embodiment, the heating device 68 is powered by operating the engine 14 above driver demanded power and utilizing the excess power to power the heating device 68 rather than sending the excess power to the battery pack 24.

The battery pack 24 may include one or more battery assemblies having a plurality of battery cells or other energy storage devices. The energy storage devices of the battery pack 24 store electrical energy that is selectively supplied to power various electrical loads residing on-board the electrified vehicle 12. These electrical loads may include various high voltage loads (e.g., electric machines, etc.) or various low voltage loads (e.g., lighting systems, low voltage batteries, logic circuitry, etc.).

The charging system 16 may include a charging port 72 located on the electrified vehicle 12 and a cordset 74 that is operably connectable between the charging port 72 and the external power source 70. The charging port 72 is adapted to selectively receive energy from the external power source 70, via the cordset 74, and then supply the energy to the battery pack 24 for charging the battery cells. If necessary, the charging system 16 may convert alternating current received from the external power source 70 to direct current DC for charging the high voltage battery pack 24. The charging system 16 is also configured to establish maximum available charging currents for charging the battery pack 24, among other operational parameters. The external power source 70 includes off-board power, such as utility/grid power, in one non-limiting embodiment.

The control module 76 may be part of an overall vehicle control unit, such as a vehicle system controller (VSC), or could alternatively be a stand-alone control unit separate from the VSC. In one non-limiting embodiment, the control module 76 is part of an engine control module (ECM) of the electrified vehicle 12. The control module 76 includes executable instructions for interfacing with and commanding operation of the various components of the vehicle system 56 including, but not limited to, the engine 14, the battery pack 24, the charging system 16, the valve 66 and the heating device 68. The control module 76 may include multiple inputs and outputs for interfacing with the various components of the vehicle system 56. The control module 76 may additionally include a processing unit and one or more types of memory for executing the various control strategies and modes of the vehicle system 56.

In one non-limiting embodiment, the control module 76 is configured to selectively open the valve 66 and actuate the heating device 68 to augment warming the oil 58 of the engine 14. Once the valve 66 is opened, heated coolant C from the secondary coolant loop 64 mixes with the coolant C of the primary coolant loop 62. The heating device 68 adds additional heat to the coolant C that can then be used to warm the oil 58 to a temperature sufficient to clean the oil 58 of contaminants, thereby speeding up oil warm-up times. In another non-limiting embodiment, the control module 76 is configured to determine when to start and stop conditioning the engine 14 using the heating device 68. In yet another non-limiting embodiment, the control module 76 is configured to determine when the start and stop charging the battery pack 24 and determine the charging rate that should be used. These are but several non-limiting examples of the many functions of the control module 76 of the vehicle system 56.

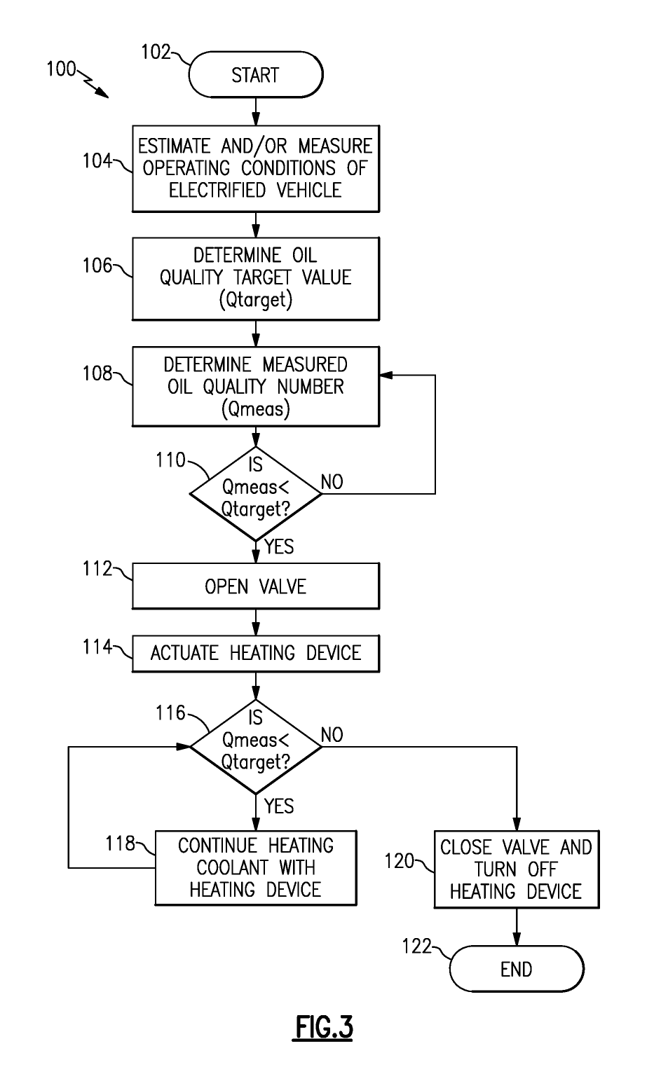

FIG. 3, with continued reference to FIGS. 1-2, schematically illustrates a control strategy 100 for actively influencing the oil quality of the oil 58 used by the engine 14 of the electrified vehicle 12. The oil quality is “influenced” in by removing contaminants from the oil 58 after the oil quality has fallen below a threshold value. The exemplary control strategy 100 may include actively monitoring an oil quality value associated with the oil 58 and then adjusting operation of the conditioning system 60 based on the monitored oil quality value. Of course, the electrified vehicle 12 is capable of implementing and executing other control strategies within the scope of this disclosure. In one non-limiting embodiment, the control module 76 is programmed with one or more algorithms adapted to execute the control strategy 100, or any other control strategy. The control strategy 100 may be stored as executable instructions in the non-transitory memory of the control module 76, in one non-limiting embodiment.

As shown in FIG. 3, the control strategy 100 begins at block 102. At block 104, the control module 76 may estimate and/or measure various operating conditions of the electrified vehicle 12. For example, the control module 76 may receive sensory feedback from one or more sensors associated with the vehicle system 56. Exemplary operating conditions include, but are not limited to, engine 14 temperature, battery pack 24 state of charge (SOC), ambient conditions, etc.

Next, at block 106, the control strategy 100 may determine an oil quality target value Q_{target}. The oil quality target value Q_{target} represents the threshold against which a measured oil quality value Qₘₑₐₛ is compared to determine whether the oil quality of the oil 58 of the engine 14 has deteriorated to such a level that corrective action is required. In one non-limiting embodiment, the oil quality target value Q_{target} is a quantitative value that can be expressed generically as an integer between the numbers 1 and 10. The oil quality target value Q_{target} may be set at any value and is a design specific parameter of the control strategy 100. In one non-limiting embodiment, the oil quality target value Q_{target} is stored in the memory of the control module 76, such as within a look-up table. In another embodiment, the oil quality target value Q_{target} is a variable value that could change based on ambient temperatures, vehicle speed, etc.

Next, at block 108, the measured oil quality value Qₘₑₐₛ associated with the oil 58 used by the engine 14 may be measured or inferred. The measured oil quality value Qₘₑₐₛ can be expressed generically as an integer between 0 and 10 and represents an estimate of the amount of contaminants within the engine oil, with ‘0’ representing relatively poor oil quality and ‘10’ representing relatively good oil quality, for example. The measured oil quality value Qₘₑₐₛ may be estimated based on one or more operating conditions of the electrified vehicle 12. In one non-limiting embodiment, the operating conditions include the number of cold starts of the engine 14 (i.e., the number of times the engine 14 is forced into operation). The measured oil quality value Qₘₑₐₛ could be estimated based on a single engine parameter or a combination of engine parameters within the scope of this disclosure.

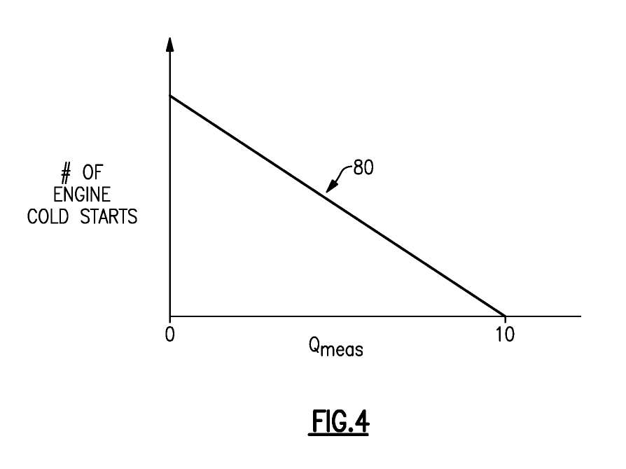

An exemplary plot 80 of the measured oil quality value Qₘₑₐₛ is shown in FIG. 4. As illustrated, the measured oil quality value Qₘₑₐₛ (shown on the X-axis) may be a function of the number of engine cold starts (shown on the Y-axis). As also indicated by the plot 80, the measured oil quality value Qₘₑₐₛ decreases as the number of cold starts increases. In other words, the measured oil quality value Qₘₑₐₛ is inversely related to the number of engine cold starts.

Referring again to FIG. 3, the measured oil quality value Qₘₑₐₛ is next compared against the oil quality target value Q_{target} at block 110. If the measured oil quality value Qₘₑₐₛ exceeds the oil quality target value Q_{target}, the control strategy 100 returns to block 108 and actively continues to monitor the measured oil quality value Qₘₑₐₛ.

If, however, the measured oil quality value Qₘₑₐₛ is determined to be less than the oil quality target value Q_{target} at block 110, indicating that the oil quality has dropped below a desired threshold of quality, the control strategy 100 may proceed to block 112 by opening the valve 66, thereby fluidly connecting the primary and secondary coolant loops 62, 64 of the conditioning system 60. The heating device 68 is powered ON at block 114 to augment warming of the oil 58 of the engine 14. For example, actuating the heating device 68 warms the coolant C in the secondary coolant loop 64, which has already been fluidly connected to the primary coolant loop 62 by virtue of opening the valve 66. The warmed coolant C may therefore be communicated through the engine 14 for adding additional heat to the oil 58. The oil 58 is heated to a temperature sufficient to clean the oil 58 of contaminants. In one non-limiting embodiment, the contaminants are boiled out of the oil 58 due to the additional heat that is added to the coolant C by the heating device 68.

In one non-limiting embodiment, the heating device 68 is powered by the battery pack 24, such as during a drive cycle of the electrified vehicle 12. In another non-limiting embodiment, the heating device 68 is powered by the external power source 70, such as during on-plug conditions in which the corset 74 is connected to both the charging port 72 and the external power source 70. In this way, the oil 58 can be cleaned of contaminants whether or not the electrified vehicle 12 is currently in operation.

After a predefined amount of time, which may be programmed in the control module 76 or stored in another look-up table, the measured oil quality value Qₘₑₐₛ is again compared against the oil quality target value Q_{target} at block 116. The control strategy 100 continues to warm the oil 58 by heating the coolant C with the heating device 68 at block 118 if the measured oil quality value Qₘₑₐₛ remains less than the oil quality target value Q_{target}. Alternatively, if the measured oil quality value Qₘₑₐₛ is determined to exceed the oil quality target value Q_{target} after the predefined amount of time, the valve 66 is closed and the heating device 68 is actuated OFF at block 120. The control strategy 100 may then end at block 122.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

We claim:

1. A method, comprising:
selectively powering a heating device to augment heating of an engine oil associated with an engine of a vehicle in a manner that influences an oil quality value of the engine oil.

2. The method as recited in claim 1, comprising determining a measured oil quality value of the engine oil.

3. The method as recited in claim 2, wherein determining the measured oil quality value includes estimating the measured oil quality value based on at least one operating condition of the internal combustion engine.

4. The method as recited in claim 3, wherein the at least one operating condition is a number of cold starts of the internal combustion engine.

5. The method as recited in claim 2, comprising comparing the measured oil quality value to an oil quality target value.

6. The method as recited in claim 5, comprising continuing to actively monitor the measured oil quality value if the measured oil quality value exceeds the oil quality target value.

7. The method as recited in claim 1, wherein the heating device is powered by a battery pack.

8. The method as recited in claim 1, wherein the heating device is powered by running the engine at a power level that exceeds driver demanded power and then utilizing the excess power to power the heating device.

9. The method as recited in claim 1, comprising opening a valve to allow coolant that is heated by the heating device to be communicated to the engine in order to heat the engine oil.

10. The method as recited in claim 9, comprising closing the valve and turning the heating device OFF after a predefined amount of time.

11. A method, comprising:
warming an engine coolant with heat generated by a heating device of a conditioning system configured to condition an engine of an electrified vehicle; and
warming engine oil with the engine coolant to a temperature sufficient to remove contaminants from the engine oil.

12. The method as recited in claim 11, comprising opening a valve of the conditioning system to communicate the engine coolant heated by the heating device to the engine.

13. The method as recited in claim 11, comprising comparing a measured oil quality value to an oil quality target value prior to warming the engine coolant.

14. The method as recited in claim 13, comprising warming the engine coolant if the measured oil quality value is less than the oil quality target value.

15. The method as recited in claim 14, comprising turning the heating device OFF after a predefined amount of time if the measured oil quality value exceeds the oil quality target value.

16. An electrified vehicle, comprising:
a battery pack configured to selectively power a set of drive wheels;
an engine configured to selectively power said drive wheels;
a conditioning system configured to condition said engine; and
a control system configured to control said conditioning system to influence an oil quality value of oil of said engine.

17. The electrified vehicle as recited in claim 16, wherein said control system includes a heating device configured to heat an engine coolant that is used to heat said oil.

18. The electrified vehicle as recited in claim 17, wherein said heating device is a positive temperature coefficient (PTC) heater.

19. The electrified vehicle as recited in claim 16, wherein said control system is configured to open a valve and actuate a heating device to influence said oil quality value of said oil.

20. The electrified vehicle as recited in claim 16, wherein said conditioning system includes a primary coolant loop and a secondary coolant loop.
